(19) United States
(12) Patent Application Publication
(10) Pub. No.: US 2005/0081382 A1
(43) Pub. Date: Apr. 21, 2005

(54) Apparatus and method for making a shaped spring assembly

(75) Inventors: Anthony K. Bischoping, Webster, NY (US); Michael J. Chapman, Churchville, NY (US)

Correspondence Address: Milton S. Sales;Patent Legal Staff, Eastman Kodak Company, 343 State Street, Rochester, NY, 14650-2201, US

(73) Assignee: Eastman Kodak Company

(21) Appl. No.: 10/689,204

(22) Filed: Oct. 20, 2003

(51) Int. Cl. B23P 15/16; B23P 13/00

(52) U.S. Cl. 29/896.9; 29/896.93; 72/462

(57) ABSTRACT

A method and apparatus for making a shaped-spring assembly. The method and apparatus utilizes a multifunctional tool or apparatus which permits the forming, storing and loading of shaped springs into a shaped spring cavity so as to form a shaped-spring assembly. The tool of the present invention permits the formation and storage of the shaped springs without fatiguing the spring, and also permits the loading of the shaped spring into a shaped-spring cavity in a manner that does not result in too large or too low of spring force for the shaped spring assembly.

### FIELD OF THE INVENTION

The present invention relates to an apparatus and method for making a shaped-spring assembly for use in a magnetic head-to-media backer device. More specifically, the present invention relates to an apparatus and method, wherein a multifunctional tool or apparatus can be used to form a shaped spring from a spring blank, store the shaped spring and load the shaped spring into a shaped spring cavity to form a shaped spring assembly.

### BACKGROUND OF THE INVENTION

Shaped-spring assemblies have been used in a number of electrical and mechanical devices such as cameras, tape decks, sound recording devices, and automated materials handling machinery. These shaped-spring assemblies are commonly called bubble-spring assemblies and are employed in situations that require a constant load with the ability to accommodate large spacial displacements. A typical bubble-spring assembly provides a restraining force against a moving piece of a magnetic section of a film, so that the film is held against a recording head under constant pressure.

A bubble-spring assembly typically includes a cavity that comprises a block and the bubble spring. The cavity includes a shaped-hollow cavity formed through the block and the bubble spring is typically small and thin. Due to the size of the spring, delicate handling of the spring is required. The bubble spring is positioned within the cavity to form a convex or arched portion that extends beyond the dimension of the cavity block. In this manner, the bubble spring is placed under tension and will thereby provide a spring force against an article, such as film, that has displaced the spring into the cavity. Prior to shaping and insertion into the cavity, the bubble spring is a flat elongated piece of thin material, typically metal, and commonly referred to as a spring blank. This type of bubble spring assembly is disclosed in, for example, U.S. Pat. Nos. 5,274,522 and 5,531,008.

As an example, in a conventional APS filmstrip, there is a magnetic layer that provides a way to read and/or write data. The above-mentioned U.S. Pat. No. 5,274,522 as noted above, discloses a bubble spring load pad that is a film backer pad used for urging the film base to a magnetic head. This backer pad (also known as a bubble spring assembly) includes a cavity and the bubble spring. After extended use of the assembly including the bubble spring, it has been found that the spring needs to be routinely replaced. This is due to the constant urging of the bubble spring against the magnetic layer of the film. Due to cost, it is not economically feasible to replace both the cavity and the bubble spring each time the spring needs to be replaced. It is preferred to use the existing cavity and install a new spring. However, as noted above, the springs tend to be small and thin, and thus very difficult to accurately replace within a small cavity without adversely affecting the spring characteristics of the spring. Also, in reloading bubble springs within a cavity, manufacturers and/or consumers may use springs from manufacturers that may provide poor spring performance due to inferior material and/or manufacturing methods.

A method of replacing a spring as disclosed in the above-mentioned U.S. Pat. No. 5,531,008 is complex and has a fair amount of cost and usage difficulty associated with it. The apparatus as disclosed in U.S. Pat. No. 5,531,008 also only supplies one spring at a time. Further, the method of spring installation as disclosed in the U.S. Pat. No. 5,531,008 causes the leading half of the spring to be fatigued during spring installation by the way the leading edge of the spring gets forced into, then around, a tight radius. This causes the leading half of the spring to be fatigued. This may cause the spring load to be lower in head load after spring installation than is desired. That is, the film has what is called an anticlastic effect (edge curl) under the edge of the film on/or close to the magnetic head track signal location. Under certain situations such as lower humidity and/or core set film, a lower gram load could limit the springs ability to provide the needed force on the outside track location to provide a high enough force to obtain consistent read/write signal processing.

The loading or replacement of springs needs to be done in a manner which does not result in too large or too low of a spring force, since a large spring force would tend to damage the film or article that the spring rides against, and a low spring force would not provide enough of a force to urge the spring against, for example, a magnetic head.

U.S. Pat. Nos. 6,470,572 and 6,594,903 to Eastman Kodak Company disclose arrangements for forming shaped spring assemblies wherein the loading or replacement of spring can be done in a manner that does not result in too large or too low of a spring force. However, the arrangements of U.S. Pat. Nos. 6,420,572 and 6,594,903 require a first tool for shaping a spring blank into a shaped spring, and a second tool for storing the shaped spring and loading the stored shaped spring into a cavity to form a shaped spring assembly. Therefore, U.S. Pat. Nos. 6,470,572 and 6,594,903 disclose the use of separate tools, one tool for forming the shaped springs and a second tool for storing the shaped springs and loading the shaped springs into a shaped spring cavity. Further, the arrangement of these two patents require the cooperation of the two tools when the shaped springs are to be transferred or loaded from the first tool to the second tool which adds labor and requires the association of the first tool with the second tool.

What is needed is a multifunctional tool or apparatus that can form shaped springs from spring blanks, can store the shaped springs, and can load the shaped springs into a cavity without requiring the cooperation and/or use of separate tools. What is further needed is a multi-functional tool or apparatus as noted above which can load or replace springs in a manner which does not result in too large or too low of a spring force, since a large spring force would tend to damage the film or article that the spring rides against, and a low spring force would not provide enough of a force to urge the spring against, for example, a magnetic head.

### SUMMARY OF THE INVENTION

The present invention provides for an improved method and apparatus for making a bubble spring (hereinafter referred to as a shaped-spring) assembly. The method and apparatus of the present invention utilizes a novel multifunctional tool or apparatus which is adapted to form a shaped spring from a spring blank, store the shaped spring and load the shaped spring into a shaped spring cavity to form a shaped spring assembly.

The present invention further provides for a mechanism and method that reduces or eliminates the necessity of installing undesired springs from manufacturers that may use unapproved springs which can cause poor performance. This is because the present invention provides for a magazine that can be pre-loaded at a controlled location.

The present invention therefore relates to a method of shaping a spring blank to form a shaped spring which comprises the steps of placing a spring blank at an opening of an elongated slot; placing a spacer member adjacent to the spring blank; and pushing the spacer member against the spring blank to urge both the spring blank and the spacer member through the opening and into the elongated slot, and cause the spring blank to wrap around an outer surface of the spacer member, wherein the spring blank conforms to a shape of the outer surface of the spacer member to form a shaped spring.

The present invention further relates to a spring shaping apparatus adapted to form shaped springs, store the formed shaped springs and load the formed shaped springs into a shaped spring cavity to form a shaped spring assembly. The apparatus comprises a base member having a longitudinally extending slot which is closed at a first end and open at a second end, with the slot being adapted to hold a plurality of shaped springs therein with a plurality of spacer members being provided between the shaped springs; and a platform extending from the opening at the second end of the slot. The platform is sized to hold a spring blank and a spacer member thereon in a position which permits a user to push a surface of the spacer member in a first direction against the spring blank to urge the spring blank and the spacer member into the slot, such that the spring blank wraps around the surface of the spacer member and forms a shaped spring in the slot. The platform is further adapted to hold a shaped spring cavity in a loading position on the platform, such that a shaped spring cavity can be placed in the loading position on the platform when a desired number of shaped springs with spacer members there-between are inserted into the slot, to permit a loading of a shaped spring from the slot into the cavity to form a shaped spring assembly.

The present invention further relates to a method of forming, storing, and loading shaped springs to form a shaped spring assembly which comprises the steps of: (a) placing a spring blank on a platform of a base member and adjacent to an opening of an elongated slot of the base member, with a length of the spring blank being greater than a width of the opening; (b) placing a spacer member on the platform and adjacent to the spring blank, such that the opening is on a first side of the spring blank and the spacer member is on a second side of the spring blank which is opposite to the first side; (c) pushing the spacer member in a first direction against the second side of the spring blank to urge both the spring blank and the spacer member through the opening and into the slot to cause the spring blank to wrap around an outer surface of the spacer member, wherein the spring blank conforms to a shape of the outer surface of the spacer member to form a shaped spring; (d) repeating said steps (a) to (c) until a desired number of shaped springs and spacer members are alternately positioned in a row in said elongated slot; (e) pushing a first spacer member in the slot which is closest to the opening in a second direction that is opposite to the first direction and out of the slot; (f) placing an empty shaped spring cavity on the platform of the base member; and (g) pushing a next spacer member in the slot in the second direction opposite to the first direction, to push an adjacent shaped spring toward the cavity and load the shaped spring into the cavity to form a shaped spring assembly.

The present invention further relates to spring shaping tool adapted to form shaped springs and load the formed shaped springs into a shaped spring cavity to form a shaped spring assembly. The tool comprises a base member having a slot which is adapted to hold a plurality of shaped springs therein with a plurality of spacer members being provided between the shaped springs; and a platform extending from the base member. The platform is sized to hold a spring blank and a spacer member thereon in a position which permits a user to push a surface of the spacer member in a first direction against the spring blank, so that the spring blank and the spacer member are urged into the slot to cause the spring blank to wrap around the surface of the spacer member and form a shaped spring. The platform is further adapted to hold a shaped spring cavity to permit a loading of a shaped spring from the slot into the cavity when a desired number of shaped springs are inserted into the slot, to form a shaped spring assembly.

### BRIEF DESCRIPTION OF THE DRAWINGS

FIG. 1 is an isolated perspective view of a shaped-spring assembly made in accordance with the present invention;

FIG. 2 is a perspective view of a multifunctional tool or apparatus used to form, store and load a shaped spring in accordance with the present invention;

FIG. 3 is a view of the tool or apparatus of FIG. 2 having a spring blank to be shaped provided thereon;

FIG. 4 is a view of a portion of the tool or apparatus of FIG. 2, wherein a spacer member has been pushed against the spring blank to form a shaped spring;

FIG. 5 is a view of the tool or apparatus of FIG. 2, wherein multiple spacer members having shaped springs formed and provided therebetween are shown being pushed into the elongated slot of the tool or apparatus;

FIG. 6 is a view of the tool or apparatus of FIG. 2, wherein a plurality of shaped springs with spacer members therebetween are loaded and stored in the tool or apparatus;

FIG. 7 is a view of the tool or apparatus of FIG. 2, wherein a first spacer member is moved in preparation for the forming of a shaped spring assembly;

FIG. 8 is a view of the tool or apparatus of FIG. 2, wherein a shaped spring cavity is provide in a loading position on the tool or apparatus; and

FIG. 9 is a view of the tool or apparatus of FIG. 2, wherein a shaped spring is loaded onto a cavity to form a shaped spring assembly.

### DETAILED DESCRIPTION OF THE INVENTION

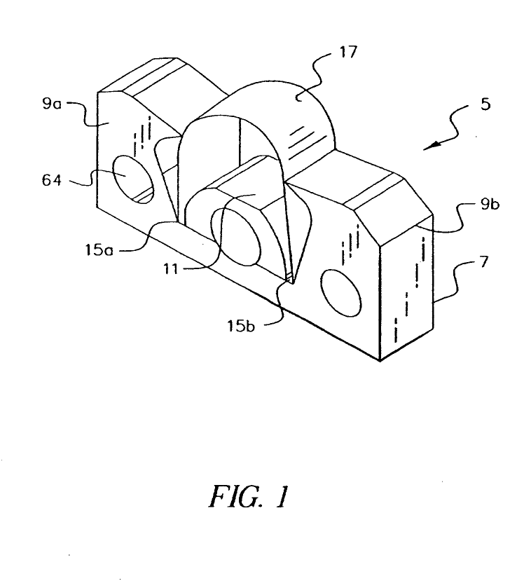

Referring now to the drawings, wherein like reference numerals represent identical or corresponding parts through the several views, FIG. 1 illustrates a shaped-spring assembly 5 that is made in accordance with the apparatus and method of the present invention. As illustrated in FIG. 1, shaped-spring assembly 5 includes a shaped-spring cavity 7 which generally comprises end sections 9a, 9b and a middle flat head section 11. The combination of end section 9a and one side of flat head section 11 defines a receiving section 15a, while end section 9b and the opposite side of flat head section 11 defines a further receiving section 15b. Shaped spring assembly 5 further includes a spring blank which is curved to form a shaped spring 17. More specifically, shaped spring 17 is curved or arched so that the arched ends are held within receiving sections 15a, 15b such that spring 17 exhibits spring-like characteristics. Thus, spring 17 is placed under tension within shaped-spring cavity 7, so as to provide a spring force against an article, such as, the film of a recording device or the magnetic layer of photosensitive film within a camera.

It is noted that the spring blank which forms shaped spring 17 is a delicate and fragile item. A typical spring blank has a thickness of approximately 0.0015 inches (0.0381 mm), a length of less than an inch (2.54 cm), and a width not exceeding 0.125 inches (0.317 cm). The spring blank is further commonly formed from stainless steel. In many applications, the spring blank includes a highly burnished surface that will contact super sensitive material. In an environment in which the shaped spring 17 is to contact, for example, a magnetic layer on film, it is desirable that the shaped spring not only have a predictable stress strain history resulting from the shaping process, but also retain the qualities associated with the burnished surface by avoiding even minor or hair line scratches. Thus, a precise and controlled method and apparatus are necessary so as to properly load a spring blank into shaped-spring cavity 7 to form shaped spring 17 and thereby form shaped spring assembly 5.

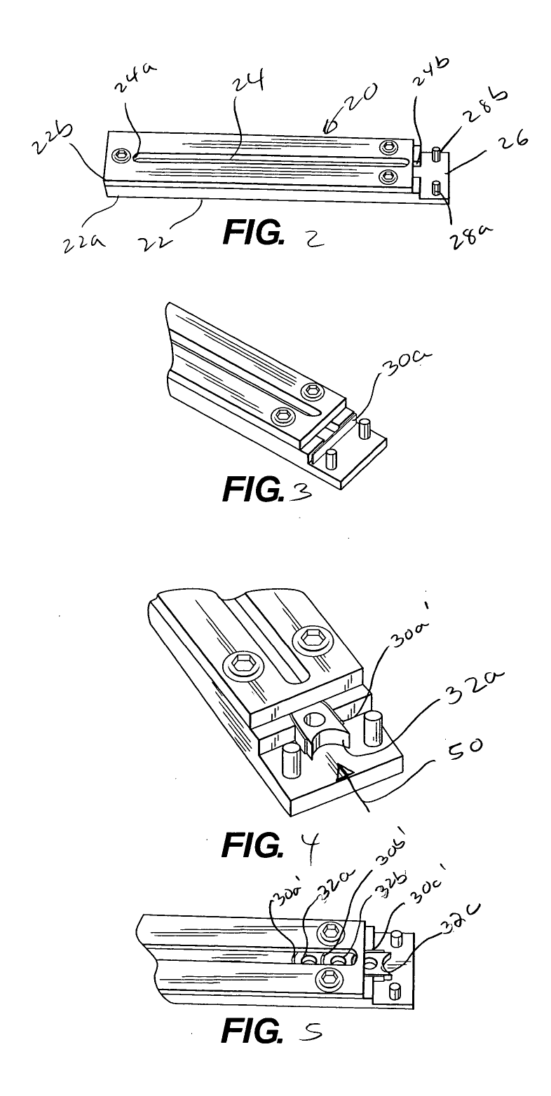

FIG. 2 illustrates a multifunctional spring shaping tool or apparatus 20 in accordance with the present invention. Spring shaping tool or apparatus 20 is adapted to form shaped springs; store the formed shaped springs and load the formed shaped springs into a shaped spring cavity. As illustrated in FIG. 2, spring shaping tool 20 includes a base member 22 which can include a first member 22a and a second member 22b provided thereon. Tool 20 further includes an elongated slot 24 that comprises a closed end 24a and an open end 24b. Open end 24b defines an opening into slot 24. As also illustrated in FIG. 2, tool 20 includes a platform 26 which includes positioning or locating pin or members 28a and 28b.

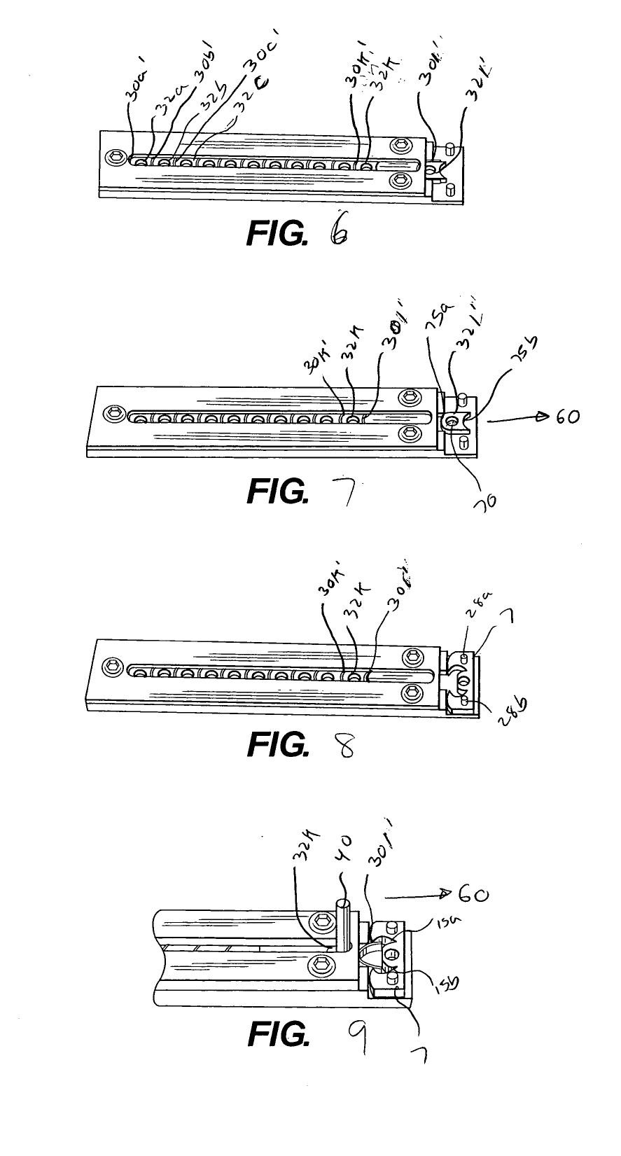

With reference to FIG. 3, a method for shaping, storing and loading shaped springs will be described. FIG. 3 illustrates a portion of tool 20 and shows a spring blank 30a provided on platform 26. Spring blank 30a generally has a length which is greater than a width of opening 24b or slot 24. The particulars of the spring blank are described above. To illustrate the shaping or conversion of spring blank 30a into a shaped spring, reference is made to FIG. 4, which illustrates a spacer member 32a provided on platform 26 and adapted to be pushed in direction 50 so as to abut against spring blank 30a. This causes a surface of spacer member 32a, and specifically a front outer surface of spacer member 32a which faces a first side of spring blank 30a to abut against spring blank 30a. Spacer member 32a preferably includes a curved outer surface 75a (see FIG. 7) which conforms to a desired shape of the spring, as well as a second curved surface 75b on an opposing side which conforms to the shape of the spring provided adjacent to this surface 75b of the spacer member. Surface 75b defines an inwardly directed curve on the spacer member. This permits an effective positioning of spacer members and springs in a row within tool 20 and specifically within elongate slot 24 as shown in FIGS. 6, 7 and 8. It is noted that the opposite or second side of spring blank 30a faces opening 24b of slot 24. Given the size relationship between slot 24 and spring blank 30a, the pushing of spacer member 32a against the side of spring blank 30a further causes spring blank 30a to wrap around the outer surface of spacer member 32a, as spacer member 32a and spring blank 30a are inserted through opening 24b and into elongate slot 24 as illustrated in FIG. 4. Therefore, as shown in FIG. 4, a shaped spring 30a′ is formed when spring blank 30a wraps around spacer member 32a. To push spacer member 32a against spring blank 30a, a user simply has to press his/her finger against the back surface of spacer member 32a, or the user can use a tool such as a small rod, bar or punch to move spacer member 32a and spring blank 30a in direction 50 and into elongate slot 24.

As illustrated in FIG. 5, tool 20 of the present invention is effective to store a plurality of spring blanks with spacer members provided therebetween. That is, as shown in FIG. 5 a user can place a further spring blank on platform 26 and push a further spacer member 32b in direction 50 so as to provide for shaped spring 30b′; and place a still further spring blank on platform 26 and push a further spacer member 32c to provide for shaped spring 30c′. A user continues this process until the desired number of shaped springs and spacer members are provided in elongate slot 24 or the elongate slot is substantially full of shaped springs and spacer members as illustrated in FIG. 6.

In the embodiment of FIG. 6, shaped springs 30a′, 30b′, 30c′, . . . 30k′ and . . . 30l′, and spacer members 32a, 32b, 32c, . . . 32k and . . . 32l′ disposed respectively therebetween are provided in slot 24. In this way, tool 20 is effective to hold a desired number of shaped springs therein to be used to form shaped springs assemblies when needed.

For the purpose of replacing or forming a shaped spring assembly, reference is made to FIGS. 7-9. As shown in FIG. 7, in order to form a shaped spring assembly a spacer member closest to opening 24b and without a shaped spring on it backside or surface 75b is first moved in direction 60. In the embodiment of FIG. 7, spacer member 32l′ is removed. Spacer member 32l′ can be removed by inserting a user's finger into slot 24 and moving spacer member 32n′ out of slot 24 or in a preferred manner, inserting a rod 40 as shown in FIG. 9 into a hole or opening 70 of spacer member 32l′.

As shown in FIGS. 8 and 9, after spacer member 32l′ is removed a shaped spring 30l′ will be exposed. A user thereafter places a cavity 7 on platform 26. As illustrated in FIG. 1, in a preferred embodiment, cavity 7 can include openings or holes 64 which cooperate with locating pins 28a, 28b on platform 26 and permit the positioning of cavity 7 in a locating position on platform 26 (FIG. 8). Thereafter, shaped spring 30l′ is moved by inserting rod or bar-like member 40 into hole 70 of spacer member 32k and moving the same in direction 60 against shaped spring 30l′ (FIG. 9). This causes shaped spring 30l′ to move in direction 60 so that the ends of shaped spring 30l′ are inserted into receiving sections 15a and 15b of cavity 7. Therefore, a shaped spring assembly which is composed of cavity 7 and shaped spring 30l′ is formed. If desired, a user can form additional shaped spring assemblies by pushing the next spacer member (i.e. spacer member 32k) out of slot 24; placing a further cavity on platform 26; and pushing the next shaped spring 32k′ into the cavity to form a further shaped spring assembly.

Although the present invention describes manually pushing the spacer members in directions 50 and 60 by way of a user's finger or a rod-like member, the present invention is not limited thereto. It is recognized that the present invention can be automated by providing for an automatic-type system which can be controlled to insert a rod or a rod-like member into opening 70 so as to push the appropriate spacer member in the desired direction. Also, other types of devices for pushing, sliding, pulling or moving an article, such as the spacer member, along the slot can also be utilized.

Therefore, the present invention provides for a multifunctional tool or apparatus which permits the forming, storing and loading of shaped springs and facilitates the shaping of springs so as to form a spring-shaped assembly.

The present invention further provides for an improved forming, storing and loading arrangement that facilitates the conversion of spring blanks into shaped springs.

With the apparatus and method of the present invention, it is possible to load empty shaped spring cavities at a controlled location, and it is also possible to convert spring blanks into shaped springs, while maintaining a predictable shaped spring history resulting from the shaping processing.

The invention has been described in detail with particular reference to certain preferred embodiments thereof, but it will be understood that variations and modifications can be effected within the spirit and scope of the invention.

1. A method of shaping a spring blank to form a shaped spring, the method comprising the steps of:
(a) placing a spring blank at an opening of an elongated slot;
(b) placing a spacer member adjacent to said spring blank; and
(c) pushing the spacer member against the spring blank to urge both the spring blank and the spacer member through the opening and into said elongated slot and cause the spring blank to wrap around an outer surface of the spacer member, wherein the spring blank conforms to a shape of the outer surface of the spacer member to form a shaped spring.

2. A method according to claim 1, further comprising:
repeating said steps (a) to (c) until a desired number of shaped springs and spacer members are alternately positioned in a row in said elongated slot.

3. A method according to claim 1, wherein said pushing step comprises pushing the spacer member against the spring blank with a tip of a user's finger.

4. A method according to claim 1, wherein said pushing step comprises pushing the spacer member against spring blank with a rod-like member.

5. A spring shaping apparatus adapted to form shaped springs, store the formed shaped springs and load the formed shaped springs into a shaped spring cavity to form a shaped spring assembly, the apparatus comprising:
a base member having a longitudinally extending slot which is closed at a first end and open at a second end, said slot being adapted to hold a plurality of shaped springs therein with a plurality of spacer members being provided between the shaped springs; and
a platform extending from said opening at the second end of the slot, said platform being sized to hold a spring blank and a spacer member thereon in a position which permits a user to push a surface of the spacer member in a first direction against the spring blank to urge the spring blank and the spacer member into the slot, such that the spring blank wraps around the surface of the spacer member and forms a shaped spring in said slot;
said platform being further adapted to hold a shaped spring cavity in a loading position on said platform, such that a shaped spring cavity can be placed in said loading position on said platform when a desired number of shaped springs with spacer members there-between are inserted into said slot, to permit a loading of a shaped spring from said slot into said cavity to form a shaped spring assembly.

6. A shaping and loading apparatus according to claim 5, wherein said platform comprises a pair of positioning protruding members which are adapted to hold said shaped spring cavity in said loading position on said platform.

7. A shaping and loading apparatus according to claim 5, wherein each of said spacer members, while in said slot, are adapted to be moved in a second direction opposite to said first direction against an adjacent shaped spring to load a shaped spring into a shaped spring cavity on said platform.

8. A method of forming, storing, and loading shaped springs to form shaped a shaped spring assembly, the method comprising the steps of:
(a) placing a spring blank on a platform of a base member and adjacent to an opening of an elongated slot of the base member, a length of said spring blank being greater than a width of said opening;
(b) placing a spacer member on said platform and adjacent to said spring blank, such that said opening is on a first side of said spring blank and said spacer member is on a second side of said spring blank which is opposite to said first side;
(c) pushing the spacer member in a first direction against the second side of said spring blank to urge both the spring blank and the spacer member through the opening and into said slot and cause the spring blank to wrap around an outer surface of the spacer member, wherein the spring blank conforms to a shape of the outer surface of the spacer member to form a shaped spring;
(d) repeating said steps (a) to (c) until a desired number of shaped springs and spacer members are alternately positioned in a row in said elongated slot;
(e) pushing a first spacer member in said slot which is closest to the opening in a second direction which is opposite to the first direction and out of said slot;
(f) placing an empty shaped spring cavity on said platform of said base member; and
(g) pushing a next spacer member in said slot in said second direction opposite the first direction, to push an adjacent shaped spring toward said cavity and load the adjacent shaped spring into said cavity to form a shaped spring assembly.

9. A method according to claim 8, wherein said pushing step in said first direction or said second direction comprises pushing the spacer member with a tip of a user's finger.

10. A method according to claim 8, wherein said pushing step in said first direction or said second direction comprises pushing the spacer member with a rod-like member.

11. A spring shaping tool adapted to form shaped springs and load the formed shaped springs into a shaped spring cavity to form a shaped spring assembly, the shaping and loading tool comprising:
a base member having a slot which is adapted to hold a plurality of shaped springs therein with a plurality of spacer members being provided between the shaped springs; and
a platform extending from said base member, said platform being sized to hold a spring blank and a spacer member thereon in a position which permits a user to push a surface of the spacer member in a first direction against the spring blank, so that the spring blank and the spacer member are urge into said slot to cause the spring blank to wrap around the surface of the spacer member and form a shaped spring;
said platform being further adapted to hold a shaped spring cavity to permit a loading of a shaped spring from said slot into said cavity when a desired number of shaped springs are inserted into said slot, to form a shaped spring assembly.
